(19) United States
(12) Patent Application Publication
(10) Pub. No.: US 2026/0117721 A1
(43) Pub. Date: Apr. 30, 2026

(54) Verfahren zum Betreiben einer H2-Brennkraftmaschine

(71) Applicant: Robert Bosch GmbH, Stuttgart (DE)

(72) Inventors: Christian Walz, Durmersheim (DE); Detlef Heinrich, Ludwigsburg (DE); Dhaval Ketanbhai Dhruv, Navasari (IN); Holger Kauss, Wernau (DE); Peter Bloch, Stuttgart-Vaihingen (DE); Rolf-Dieter Koch, Ditzingen (DE); Stephen Lindermaier, Stuttgart (DE); Tobias Rabe, Leutenbach (DE)

(21) Appl. No.: 19/240,109

(22) Filed: Jun. 17, 2025

(30) Foreign Application Priority Data
Jun. 20, 2024 (DE) 10 2024 205 734.7

(51) Int. Cl. F02D 41/14; F02D 41/00; F02D 41/40

(52) U.S. Cl. CPC F02D 41/1475; F02D 41/0027; F02D 41/405; F02D 2200/0802; F02D 2200/101; F02D 2250/38

(57) ABSTRACT

A method for operating an H2 internal combustion engine (110), wherein at least one catalytic converter (122) for converting an exhaust gas of the H2 internal combustion engine (110) is arranged in an exhaust gas system (120) downstream of the H2 internal combustion engine (110), wherein the H2 internal combustion engine (110) is supercharged by means of an exhaust gas turbocharger,

wherein a current temperature of the at least one catalytic converter (122) is determined, in particular the brick temperatures of the at least one catalytic converter (122),
wherein a current conversion capacity (η) of the at least one catalytic converter (122) is determined,
wherein, depending on the conversion capacity (η) of the at least one catalytic converter (122) and depending on an operating state of the H2 internal combustion engine (110), a limitation of a target air-fuel ratio (Asou) for the combustion of the H2 internal combustion engine (110) is carried out such that NOx emissions generated by the combustion are limited.

### BACKGROUND

The present invention relates to a method for operating an H2 internal combustion engine, as well as a control unit and a computer program for carrying out this method.

The formation of nitrogen oxides (NOx) in H2 internal combustion engines, as in conventional internal combustion engines, is highly dependent on the air-fuel ratio (λ) that prevails during the combustion process. The air-fuel ratio is a measure of how much air is present in the combustion chamber in relation to the amount of fuel used. A stoichiometric air-fuel ratio means that exactly the right amount of air is present to completely burn all the fuel.

DE 10 2021 208 258 A1 discloses a method (200) for determining the conversion capacity of one or more exhaust gas catalysts (11, 12, 13) downstream of an internal combustion engine (1), comprising determining (220) a local temperature at a plurality of locations within the one or more catalytic converters (11, 12, 13), determining (230) a local conversion capacity for a section or a partial volume of the one or more catalytic converters (11, 12, 13) based on the local temperature, and determining (240) a global conversion capacity of the one or more catalytic converters (11, 12, 13) based on the determined local conversion capacities.

Furthermore, a computing unit (20) and a computer program for carrying out such a method (200) are proposed.

### SUMMARY

In a first aspect, the invention relates to a method for operating an H2 internal combustion engine, wherein at least one catalytic converter for converting an exhaust gas from the H2 internal combustion engine is arranged downstream of the H2 internal combustion engine, wherein the H2 internal combustion engine is supercharged by means of an exhaust gas turbocharger,

wherein a current temperature of the at least one catalytic converter is determined, in particular the brick temperatures of the at least one catalytic converter,

wherein a current conversion capacity of the at least one catalytic converter is determined,

characterized in that, depending on the conversion capacity of the at least one catalytic converter and depending on an operating state of the H2 internal combustion engine, a limitation of a target air-fuel ratio for the combustion of the H2 internal combustion engine is carried out such that NOx emissions generated by the combustion are limited.

The method has the particular advantage that by precisely limiting the combustion chamber lambda, a reduction in NOx emissions can be achieved depending on the conversion capacity of the catalytic converter.

The effective reduction of NOx emissions from combustion reduces the need for intensive catalytic converter heating measures. This saves energy and reduces fuel consumption that would otherwise be required to heat up the catalytic converter.

By reducing NOx emissions, the strategy makes an important contribution to environmental protection and improving air quality, especially in urban areas.

In summary, the proposed strategy offers an effective and flexible solution for reducing NOx emissions from H2 internal combustion engines that minimizes environmental impact, improves the efficiency of the SCR catalytic converter, and optimizes engine performance while limiting the fuel consumption disadvantage.

In a special embodiment, a minimum permissible air-fuel ratio is determined depending on the determined conversion capacity of the at least one catalytic converter and/or a speed and/or an exhaust gas mass flow.

In an advantageous embodiment, if the target air-fuel ratio exceeds the minimum permissible air-fuel ratio, the target air-fuel ratio is limited to the minimum permissible air-fuel ratio.

In a special embodiment, when a limitation is imposed on the target air-fuel ratio, H2 is injected subsequently, in particular in addition to the main injection, in order to increase the enthalpy for the exhaust gas turbine of the exhaust gas turbocharger and the engine torque.

Since limiting the required air-fuel ratio also limits the main injection quantity and thus reduces the engine torque delivered, it is advantageous to use post-injection of H2 (after the main injection) to achieve a NOx-neutral increase in engine torque on the one hand and an increase in the enthalpy for the exhaust gas turbine of the exhaust gas turbocharger on the other, thereby counteracting the loss of torque.

In a further embodiment, the operating state of the H2 internal combustion engine is a speed and/or a load requirement for the H2 internal combustion engine.

In a special embodiment, the conversion capacity of the at least one catalytic converter is determined on the basis of the current temperature of the at least one catalytic converter and/or an exhaust gas mass flow by means of a model.

In an advantageous embodiment, the limitation of the target air-fuel ratio is only carried out during dynamic load increases.

In a special embodiment, the exhaust gas aftertreatment system comprises an SCR catalytic converter and/or an NOx storage catalytic converter.

In further aspects, the invention relates to an apparatus, in particular a control unit and a computer program, configured and in particular programmed so as to carry out any one of the methods. In yet another aspect, the invention relates to a machine-readable storage medium on which the computer program is stored.

### BRIEF DESCRIPTION OF THE DRAWINGS

FIG. 1 shows a schematic illustration of a vehicle as it can be used in embodiments of the invention.

FIG. 2 shows an example of the dependence between NOx emissions and the air-fuel ratio for an H2 internal combustion engine;

FIG. 3 shows a highly simplified embodiment of the invention in the form of a block diagram.

### DETAILED DESCRIPTION

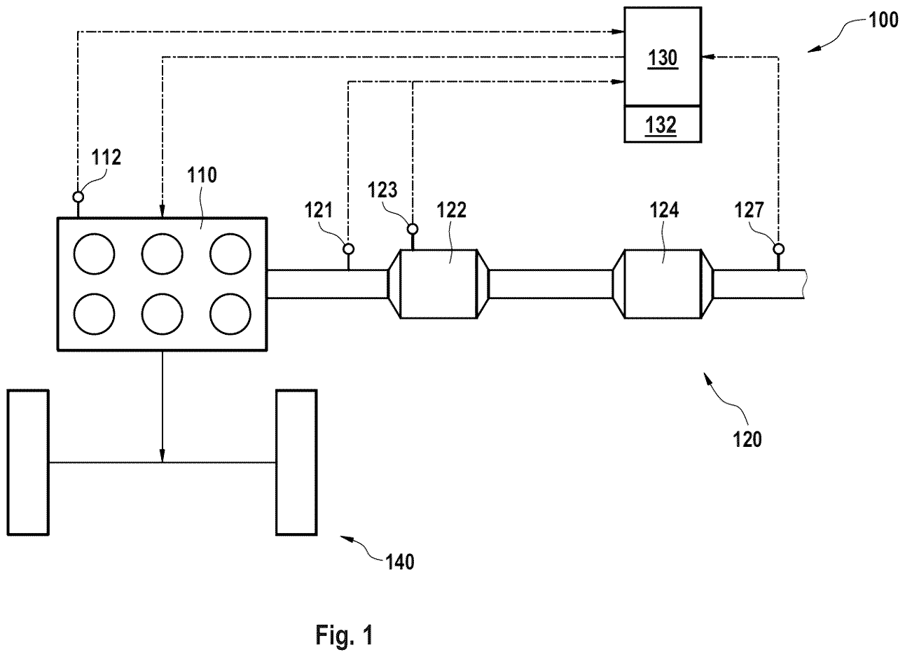

FIG. 1 schematically illustrates a vehicle that can be used in the context of the invention and is designated as 100 overall. The vehicle 100 comprises an H2 internal combustion engine 110, wherein in principle all conceivable types of reciprocating piston and rotary piston engines can be used. In the example shown here, the H2 internal combustion engine 110 comprises six cylinders with reciprocating pistons, as indicated in the drawing. The vehicle 100 further comprises an exhaust gas system 120, which has an SCR catalytic converter 122 and a further exhaust gas purification unit 124, for example a further catalytic converter or a particle filter, as well as a control unit 130, which is configured to control the H2 internal combustion engine 110 and the exhaust gas system 120 and is connected to these for data transmission.

Furthermore, in the example shown, the control unit 130 is connected to sensors 112, 121, 123, 127 for data transmission, which capture operating parameters of the H2 internal combustion engine 110 and/or the exhaust system 120. For example, the sensors may be lambda probes (in particular sensors 121, 127), NOx and/or temperature sensors 112, 123.

The lambda sensor is used to determine the current air-fuel ratio λ.

The control unit 130 controls both the injection of H2 into the cylinders, which determines the amount of fuel supplied to the combustion engine. The required fuel quantity is set by a lambda control integrated in the control unit 115, depending, among other things, on the engine load and the required lambda value, wherein the basic setting is preferably made by means of an adaptable pilot control contained in the lambda control. For this purpose, the output signal of the pilot control is added to the output signal of a lambda controller. The pilot control determines the fuel quantity based on the engine load, among other things. The relationship between the engine load and the fuel quantity to be specified is preferably stored in a characteristic map in the control unit 115.

The present invention relates to limiting the air-fuel ratio depending on the operating state of the exhaust aftertreatment system and the H2 internal combustion engine 110.

It is understood that additional and/or different sensors may be present in addition to and/or instead of the sensors mentioned, which may not be shown in the figure. The exhaust gas system 120 may also have additional cleaning components, such as additional particle filters and/or other/additional catalytic converters, which are not shown here for the sake of simplicity. For example, instead of the SCR catalytic converter, a NOx storage catalytic converter or a combination of NOx storage catalytic converter and SCR catalytic converter may be used.

In the example shown here, the control unit 130 comprises a data memory 132 in which, for example, calculation rules and/or parameters (e.g., threshold values, characteristic values of the H2 internal combustion engine 110 and/or the exhaust system 120 or the like) can be stored.

Furthermore, a model is stored on the control unit 130 which determines the NOx conversion capacity η of the at least one SCR catalytic converter 122 as a function of the respective brick temperatures of the SCR catalytic converter 122 and the exhaust gas mass flowdmₑₓₕ. The SCR catalytic converter 122 is divided into n (n>=2) virtual layers (bricks). The brick temperatures are determined by the control unit 120 using a temperature model for the SCR catalytic converter 122. Advantageously, the brick temperatures are determined based on a temperature sensor downstream of the internal combustion engine 110 and upstream of the SCR catalytic converter 122.

The model used here corresponds to the method described in patent publication DE 10 2021 208 258 A1.

The H2 internal combustion engine 110 drives wheels 140 to move the vehicle 100 and can also be driven by the wheels 140 in certain operating phases (e.g., coasting mode).

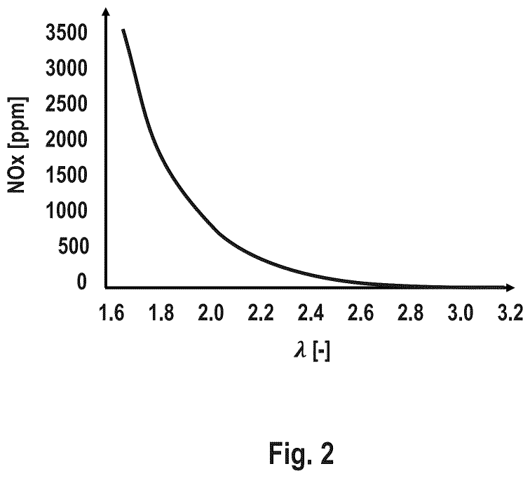

FIG. 2 shows an example of the relationship between NOx emissions and the air-fuel ratio λ for an H2 internal combustion engine.

The NOx emissions are plotted on the ordinate in parts per million and the increasing air-fuel ratio 2 on the abscissa.

Most NOx emissions occur at high temperatures and in an air-fuel ratio λ in a region between 1 and 2. At a high air-fuel ratio of λ greater than 2, the mixture burns with almost no NOx emissions. The maximum NOx emissions are produced at an air-fuel ratio of λ=1.3, after which NOx emissions decrease significantly due to a lack of oxygen.

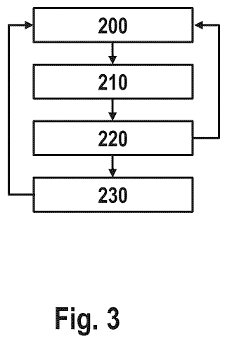

In a FIG. 3, an exemplary embodiment for the method is shown.

In a first step 200, the NOx conversion capacity η of the at least one SCR catalytic converter 122 is determined by the control unit 130.

In a preferred embodiment, the temperature of the SCR catalytic converter 122 is continuously determined by means of a temperature sensor 123.

Based on the sensor temperature, temperatures modeled as sections within the at least one SCR catalytic converter 122 are determined for several partial volumes or locations. For example, these partial volumes may represent axially consecutive discs, known as bricks. For this purpose, a physical model can be used in particular, which includes in particular the flow mechanical properties of the at least one SCR catalytic converter 110 as well as thermal properties such as heat capacity, thermal conductivity, etc. of the SCR catalytic converter 122, H2 internal combustion engine 110 and the exhaust gas. These properties can be permanently stored in a data memory of the computing unit 130, for example in the form of one or more characteristic maps, lookup tables, parameter sets, or the like.

Furthermore, the local conversion capacities are determined from the local temperatures determined in this way using dependencies (e.g., the above-mentioned light-off curve) of the conversion rate on the local temperature that are valid for the respective location or the corresponding partial volume. The dependence depends in particular on the type of at least one SCR catalytic converter 122 and on the aging of the catalytic converter, since different temperatures are required for different conversion reactions to be catalyzed and the conversion efficiency generally decreases with increasing catalyst aging. The aging of the SCR catalytic converter 110 can, for example, be determined as part of a diagnostic function and taken into account in the form of an aging parameter. The aging parameter can apply globally to the entire SCR catalytic converter 122 concerned, or it can also be determined on a location-dependent basis, since, for example, lower temperatures generally prevail in a peripheral zone of the catalytic converter than in a core zone of the SCR catalytic converter 122, and thus the core zone ages more quickly than the peripheral zone.

In this case, a single NOx conversion capacity ηᵢ, i of the number of bricks, can be determined for each brick, or an average value for the total NOx conversion capacity η of the SCR catalytic converter 122 can be determined. In the further course of the exemplary embodiment, the average value for the total NOx conversion capacity η is used.

The method then continues in a step 210.

In step 210 depending on the determined NOx conversion capacity η and, optionally, the speed of the H2 internal combustion engine 110 and/or the exhaust gas mass flow dmₑₓₕ, a minimum air-fuel ratio λₘᵢₙ for the current operating point of the H2 internal combustion engine 110 is determined by means of a characteristic map K1 stored on the control unit 130.

The characteristic map contains the dependence between the generation of NOx emissions and the air-fuel ratio λ shown in FIG. 2. This allows a minimum air-fuel ratio λₘᵢₙ to be determined from the characteristic map K1 which, for the current operating point of the H2 internal combustion engine 110 generates only so much NOx emissions that these can be optimally converted into clean exhaust products by the exhaust gas aftertreatment system and, at the same time, a driver request or torque request can be met. In an alternative embodiment, a load requirement can also be considered.

Furthermore, a known air-fuel control system for the H2 combustion engine is used to determine a target air-fuel ratio for the current operating point using various variables, such as engine speed, desired engine torque, engine operating mode, ignition angle, and inert gas rate.

The characteristic map K1 is determined in an application phase for the H2 internal combustion engine 110 and stored on the control unit 130.

The method then continues in a step 220.

In step 220 the target air-fuel ratio λₛₒₗₗ is compared with the determined minimum air-fuel ratio λₘᵢₙ.

If the comparison shows that the target air-fuel ratio λₛₒₗₗ is less than the minimum air-fuel ratio λₘᵢₙ, the minimum air-fuel ratio replaces the target air-fuel ratio λₘᵢₙ for controlling the air-fuel ratio λₛₒₗₗ.

The method then continues in a step 230.

If the target air-fuel ratio λₛₒₗₗ is greater than or equal to the minimum air-fuel ratioλₘᵢₙ, the target air-fuel ratio λₛₒₗₗ is used to control the air-fuel ration.

The method can then be continued in step 200.

In a step 230 depending on the minimum air-fuel ratio λₘᵢₙ and various variables, such as engine speed, desired engine torque, current internal engine torque, engine operating mode, ignition angle, and inert gas rate, a post-injection of H2 is determined using a characteristic map K2.

The characteristic map K2 is determined in an application phase for the H2 internal combustion engine 110 and stored on the control unit 130.

Since limiting the required air-fuel ratio also limits the main injection quantity and thus reduces the engine torque delivered, it is advantageous to use post-injection of H2 (after the main injection) to achieve a NOx-neutral increase in engine torque on the one hand and an increase in the enthalpy for the exhaust gas turbine of the exhaust gas turbocharger on the other, thereby counteracting the loss of torque.

In addition, the temperature in the exhaust aftertreatment components, such as the SCR catalytic converter, also increases.

The method then continues in a step 200.

1. A method for operating an H2 internal combustion engine (110), wherein at least one catalytic converter (122) for converting an exhaust gas of the H2 internal combustion engine (110) is arranged in an exhaust gas system (120) downstream of the H2internal combustion engine (110), wherein the H2 internal combustion engine (110) is supercharged by means of an exhaust gas turbocharger,
wherein a current temperature of the at least one catalytic converter (122) is determined,
wherein a current conversion capacity (n) of the at least one catalytic converter (122) is determined,
wherein depending on the conversion capacity (η) of the at least one catalytic converter (122) and depending on an operating state of the H2 internal combustion engine (110), a limitation of a target air-fuel ratio (λₛₒₗₗ) for the combustion of the H2 internal combustion engine (110) is carried out such that NOx emissions generated by the combustion are limited.

2. The method according to claim 1, wherein a minimum permissible air/fuel ratio (λₘᵢₙ) is determined depending on the determined conversion capacity (η) of the at least one catalytic converter (122) and/or a rotational speed (n_{eng}) and/or an exhaust gas mass flow (dmₑₓₕ).

3. The method of claim 2, wherein if the target air-fuel ratio (λₛₒₗₗ) exceeds a minimum permissible air-fuel ratio (λₘᵢₙ) the target air-fuel ratio (λₛₒₗₗ) is limited to the minimum permissible air-fuel ratio (λₘᵢₙ).

4. The method according to claim 1, wherein when a limitation for the target air-fuel ratio (λₛₒₗₗ) is carried out, a post-injection of H2 is carried out to increase an enthalpy for an exhaust gas turbine of the exhaust gas turbocharger and an engine torque.

5. The method according to claim 1, wherein the operating state of the H2 internal combustion engine (110) is a rotational speed (n_{eng}) and/or a load requirement for the H2 internal combustion engine (110).

6. The method according to claim 1, wherein conversion capacity (η) of the at least one catalytic converter (122) is determined based on the current temperature of the at least one catalytic converter (122) and/or an exhaust gas mass flow (dmₑₓₕ) by means of a model.

7. The method according to claim 1, wherein the limitation of the target air-fuel ratio (λₛₒₗₗ) is only carried out in the event of a dynamic load increase.

8. The method according to claim 1, wherein the exhaust gas system comprises an SCR catalytic converter (122) and/or an NOx storage catalytic converter.

9. (canceled)

10. A non-transitory, computer-readable medium containing instructions that when executed by a computer cause the computer to control operation of an H2 internal combustion engine (110), wherein at least one catalytic converter (122) for converting an exhaust gas of the H2 internal combustion engine (110) is arranged in an exhaust gas system (120) downstream of the H2 internal combustion engine (110), wherein the H2 internal combustion engine (110) is supercharged by means of an exhaust gas turbocharger, by
determining a current temperature of the at least one catalytic converter (122),
determining a current conversion capacity (η) of the at least one catalytic converter (122), and
limiting, based on the conversion capacity (η) of the at least one catalytic converter (122) and an operating state of the H2 internal combustion engine (110), a target air-fuel ratio (λₛₒₗₗ) for the combustion of the H2 internal combustion engine (110) such that NOx emissions generated by the combustion are limited.

11. A control unit (130), which is configured to control operation of an H2 internal combustion engine (110), wherein at least one catalytic converter (122) for converting an exhaust gas of the H2 internal combustion engine (110) is arranged in an exhaust gas system (120) downstream of the H2 internal combustion engine (110), wherein the H2 internal combustion engine (110) is supercharged by means of an exhaust gas turbocharger, by
determining a current temperature of the at least one catalytic converter (122),
determining a current conversion capacity (η) of the at least one catalytic converter (122), and
limiting, based on the conversion capacity (η) of the at least one catalytic converter (122) and an operating state of the H2 internal combustion engine (110), a target air-fuel ratio (λₛₒₗₗ) for the combustion of the H2 internal combustion engine (110) such that NOx emissions generated by the combustion are limited.
